(19) United States
(12) Patent Application Publication
(10) Pub. No.: US 2008/0149355 A1
(43) Pub. Date: Jun. 26, 2008

(54) Fire Extinguishing and Gas and Oil Well Recovery System

(76) Inventor: Francisco Joven Marco, Zaragoza (ES)

Correspondence Address: NOTARO AND MICHALOS, 100 DUTCH HILL ROAD, SUITE 110, ORANGEBURG, NY, 10962-2100, US

(21) Appl. No.: 11/814,885

(22) PCT Filed: Feb. 1, 2006
(86) PCT No.: PCT/ES2006/000041

§ 371 Date: Jul. 26, 2007

(30) Foreign Application Priority Data
Feb. 2, 2005 (ES) P200500185

(51) Int. Cl. A62C 3/06; A62C 2/00; A62C 27/00

(52) U.S. Cl. 169/69; 169/52; 169/70; 169/48

(57) ABSTRACT

Fire extinguishing and oil and gas well recovery system, which is particularly suitable for use in oil and petrochemical mining, characterised in that it comprises a detailed sequence of operations that are performed by means of a special caterpillar vehicle that can move safely over difficult terrain or through the desert. The vehicle can be used to approach the well while guaranteeing the safety of individuals, to position the explosive charge and detonate it for the subsequent recovery of the well.

The special vehicle is equipped with an articulated arm, which together with a jib crane can handle any type of element, a front hydraulic shovel; rear motorisation, a control cabin and several pressurised water canons. The whole unit is heat-protected by means of special thermal insulation.

The present document relates, as its title indicates, to a fire extinguishing and oil and gas well recovery system, which is particularly suitable for use in oil and petrochemical mining, characterised in that it comprises a detailed sequence of operations that are performed by means of a special caterpillar vehicle that can move safely over difficult terrain or through the desert. The vehicle can be used to approach the well while guaranteeing the safety of individuals, to position the explosive charge and detonate it for the subsequent recovery of the well.

The special vehicle is equipped with an articulated arm, which together with a jib crane can handle any type of element, a front hydraulic shovel; rear motorisation, a control cabin and several pressurised water canons. The whole unit is heat-protected by means of special thermal insulation.

At the present time there are different ways of trying to extinguish the fires that occur in oil or gas wells.

Extinguishing operations and well recovery are carried out when environmental conditions are optimum, which means that there is a great loss of crude oil if a number of days have to be waited before the well can be dealt with.

The work involved in the recovery of a well is very dangerous due to the high temperatures in the vicinity of the well, and sometimes accidents occur amongst operators.

At the current time, in well extinguishing and recovery operations different public works machines are used that are not equipped to perform these functions.

Whilst one group of machines has the mission of removing elements from the vicinity of the fire, another group acts as water sprayers, to cool down the working area.

Fire extinguishing and the detonation of explosives are carried out in unsuitable conditions, with failed attempts, due to the fact that the machines are not built for this task.

An oil well fire causes a wide diversity of vehicles and persons to be mobilised, making coordination between them a difficult task and this can result in extinguishing and recovery operations being both slow and costly.

This also results in the major drawback of the considerable cost involved in an incident of this type, the vehicles employed and the corresponding team involved, the large amounts of oil lost and, in some cases, the high risk of accidents for the persons involved.

To resolve the current problems, a fire extinguishing and oil and gas well recovery system has been designed that is based on a sequence of operations carried out by means of a special vehicle that comprises all of the mechanical elements required for fire extinguishing and well recovery procedures and which also requires a reduced number of personnel.

With the vehicle it is possible to approach the well, reducing the danger of accidents to personnel and ensuring better positioning and detonating of explosives.

Furthermore the enormous loss of crude oil, ecological damage and contamination of the environment is reduced given that the vehicle allows the operations to be carried out on the well without having to wait for the most favourable conditions, allowing them to be performed in a relatively short period of time.

The system maintains the following sequence of phases:

### Phase 1: Positioning of Shields:

Protective metallic shields are strategically placed on the terrain. These shields allow fire fighters or specialised personnel to take shelter in order to be able to safety direct the water from the water canons at the well on fire and its surrounds.

### Phase 2: Cooling the Surrounding Area:

Water is aimed at the flames of the oil well on fire, from the shields positioned at ideal sites, and from the vehicle itself. Water can be supplied from the reservoirs that are built near to oil mines to prevent such incidents.

### Phase 3: Cleaning and Protection of Surrounding Area:

The vehicle is fitted with a hydraulic shovel and telescopic arm with a bucket to carry out these vitally important operations simultaneously, since the cleaning and protection of the surrounding area is of great use in preventing serious accidents.

The bucket is positioned at the end of telescopic arm and has a long scope that allows it to remove elements very easily. In addition the front of the vehicle incorporates a hydraulic shovel with sufficient earth-moving capacity to allow the vehicle to be frontally concealed by a parapet of earth protecting it from the excessive heat caused by the well explosion.

### Phase 4: Explosives and Detonation:

In its structure the vehicle incorporates an articulated arm with a pincer at its free end which, in addition to being able to carry out any operation, is specially designed to hold an extension that has the explosive charge at the end and place it at the wellhead, detonating the explosion.

### Phase 5: Extinguishing:

To extinguish the fire at the well, explosives or liquid nitrogen can be used. The choice will depend on the characteristics of the well. The vehicle is totally effective in both cases because it can approach within less than 18 metres of the well and, with the articulated arm and pincer, position and detonate the explosive charge, if this solution is chosen.

In the event of opting for the solution of extinguishing the fire using liquid nitrogen, a chimney or tube must be placed at the wellhead using the articulated arm pincer (holding the bottom part) and, by means of the hook on the telescopic crane bucket (holding the top part). Once it is in place, liquid nitrogen is poured inside it using a hose that is housed inside the articulated arm structure.

### Phase 6: Recovery of the Well:

Once the fire has been extinguished, a chimney or tube is placed at the wellhead, repeating the same steps as in the previous phase, to then carry out the clamping operations and the fitting of a new BOP or Christmas tree so that the well is totally recovered and ready for operation.

The special vehicle comprises a commercial chassis on caterpillar tracks, which are powered by the corresponding motorisation, capable of providing the movement of the unit, as well as the power required for the different elements that form it.

The front of the vehicle is fitted with a hydraulically-operated articulated arm, capable of moving both to the left and to the right, up and down or vice versa, which has the characteristic of being able to channel water towards the water canons, thanks to the design of its triangular metallic structure, formed by cylindrical tubes, through which the water flows.

At the free end of the arm there is a pressurised water canon as well as a pincer for different operations, to place an extension with explosives at the wellhead, to help hold and transport the chimney tube, to mount of the “Christmas tree”, to hold and transport the chimney tube when applying liquid nitrogen to the well, as well as acting as a support for the liquid nitrogen pipe, insulated with asbestos, and being of use in the detonation of explosives.

Towards the centre of the chassis there is a turntable on which is mounted a jib crane, comprising several telescopic sections in its horizontal sector, being electro-hydraulically driven, devised for the removal of different objects during the holding and transporting the chimney-tube, mounting of the “Christmas tree” (together with the articulated arm), holding and transporting of the chimney tube for applying liquid nitrogen to the well (together with the articulated arm), transporting and positioning of the heat shields for water canons and the tasks that are characteristic of a crane.

The free end of the jib crane has a hydraulic shovel fitted, essentially for digging protection ditches that allow the unit to approach the fire.

The central core of the vehicle is protected by an enveloping casing, made of stainless steel, as well as by a sprayer for external auto-cooling.

At the front of the unit, towards the upper part of the cabin, are positioned several water canons for cooling the wellhead and the surrounding area, as well as several mechanisms; the canon anchored to the free end of the articulated arm also assists in this task.

To protect the cabin safety shield, the opportune thermal insulation is provided, along with the corresponding insulation for the motorisation, which, in this case contains an air inlet, with cooling and filtering to the exterior.

The control and operating cabin is built with fire-resistant materials, incorporating the corresponding cooling and air renewal system and including the necessary optical sights for the management of operations, driving of the vehicle, operating of the articulated arm, the crane, the shovel and water canons.

As far as hoses are concerned, a plurality of these is provided, equipped with the corresponding connection support and folding guide support.

Also provided are numerous vertically-acting support points as well as a counterweight to guarantee the correct centre of gravity of the vehicle assembly when in action.

This fire extinguishing and oil and gas well recovery system that is presented provides multiple advantages over the systems currently used, and principally that all of the phases of the system are carried out with a special vehicle that brings together, in one single unit, multiple elements needed to perform said task, such as the articulated arm fitted with a pincer at its end, the jib crane, the excavator shovel, water canons and hose equipment, all of these elements being controlled by a minimum number of persons, thus representing an important economic saving on labour and capital goods.

Another of the important advantages is that the special vehicle moves on caterpillar-type tracks, facilitating its movements over rough or desert terrains, with a certain degree of agility and safety. Another advantage is the incorporation of the hydraulic shovel, which can open up the way to facilitate access of the unit and which can dig ditches that protect it from high temperatures, allowing the approach to the well on fire.

A further advantage consists of its safety shield protection, insulation and auto-cooling system, since the vehicle must withstand high temperatures and be protected from impacts that may occur during the explosion provoked to extinguish the fire at the well, given that the vehicle can approach within at least 18 m of the well on fire and, by means of the articulated arm, and the pincer at its end, it can position the corresponding explosive charge in the appropriate place, and then detonate the charge from the cabin.

Likewise, it provides an advantage in comparison to other known means, when extinguishing is carried out with liquid nitrogen, given that the chimney with the hose for introducing the nitrogen can be placed in position using the articulated arm pincer, gripping the bottom part, with the aid of the telescopic crane hook holding the top part. This same gripping or holding system is used to install the corresponding chimney once the fire has been extinguished, to carry out clamping operations, fitting of a new BOP or the “Christmas tree”.

It also boasts the advantage that it is applicable to both oil and gas wells, being able to be handled from the cabin by three persons, who control the different functions such as the driving of the vehicle, coordination of operations in communication with the exterior, maintenance, water intake, etc.), handling of the articulated arm with hydraulic pincer, operating of water canons and operating of hydraulic outriggers.

Lastly, we can cite as an important advantage provided by the system presented, the ease and speed with which fires are extinguished, which, in addition to the previously described advantages, logically allows large quantities of crude oil to be saved, whilst also reducing ecological damage, contamination of the environment, etc. and ensures the maximum possible safety of technical experts, fire fighters and specialised personnel.

To gain a better understanding of the object of the present invention, the drawing attached, shows a preferred practical embodiment of the same. In said drawing:

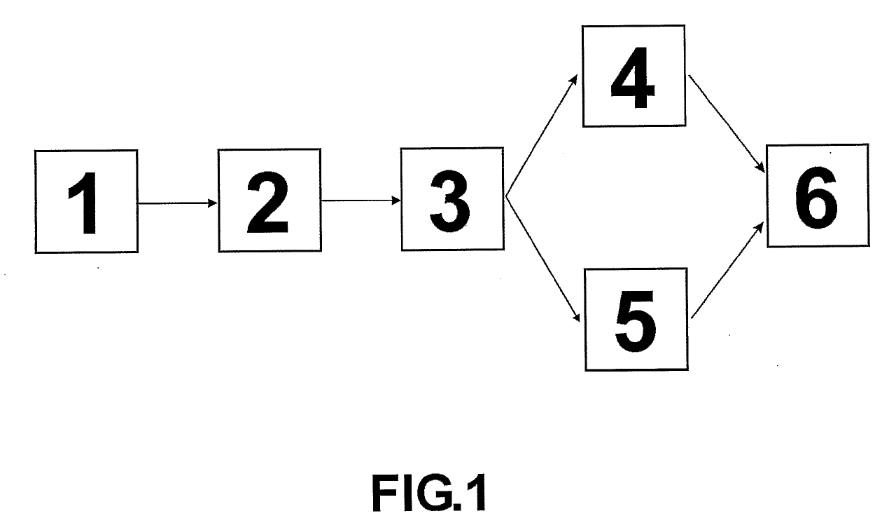

FIG. 1—is a block diagram that develops the different phases in the system.

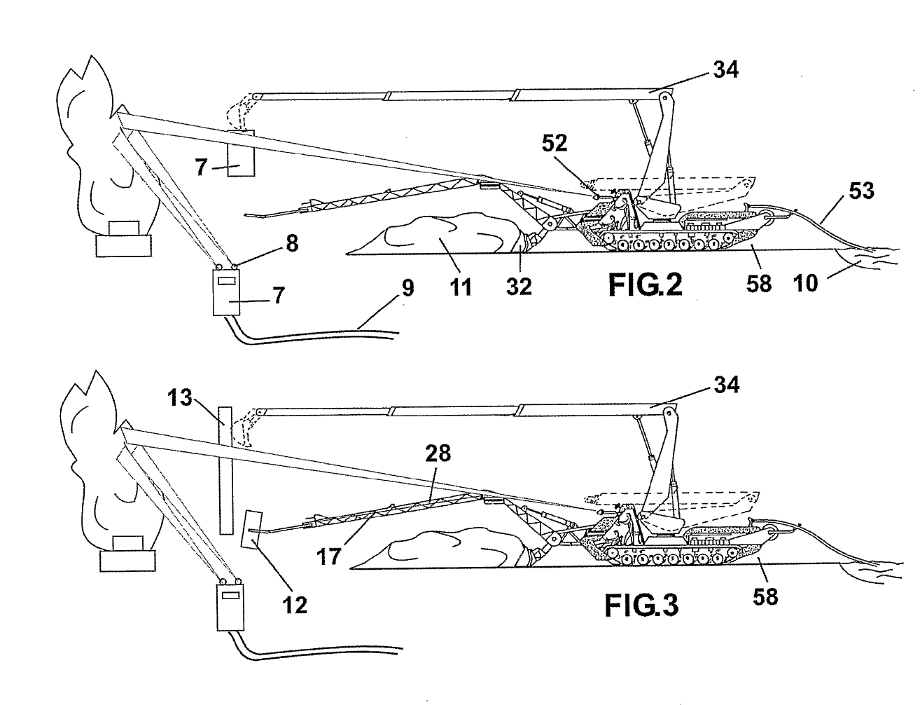

FIG. 2—is a schematic view of the development of the system in phases 1, 2 and 3.

FIG. 3—is a schematic view of the development of the system in phases 4 and 5.

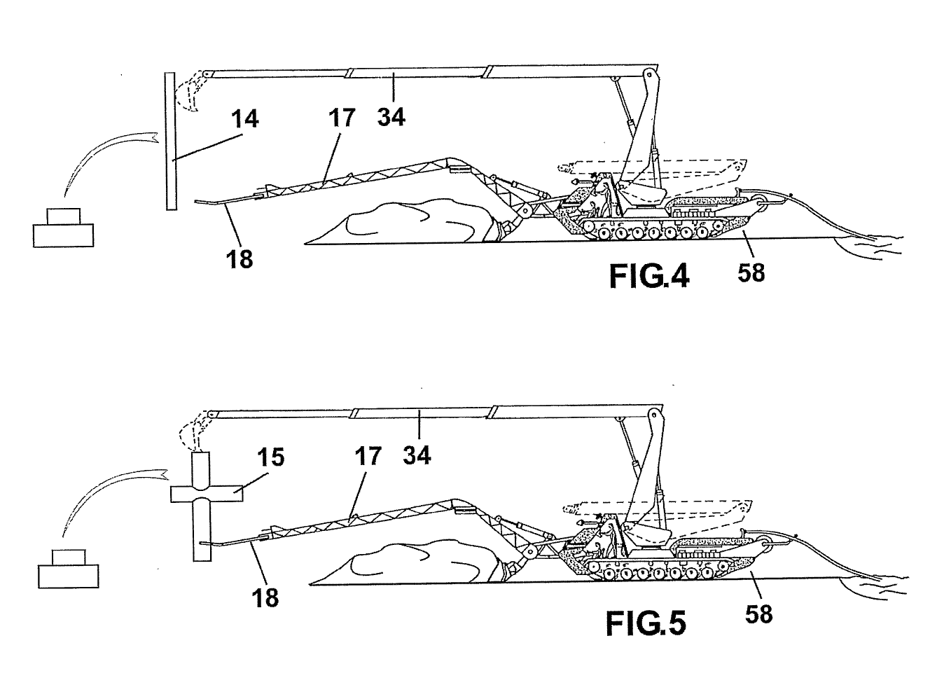

FIG. 4—is a schematic view of the development of the system in phase 6, placing the chimney or tube in position.

FIG. 5—is a schematic view of the development of the system in phase 6, placing the Christmas tree in position.

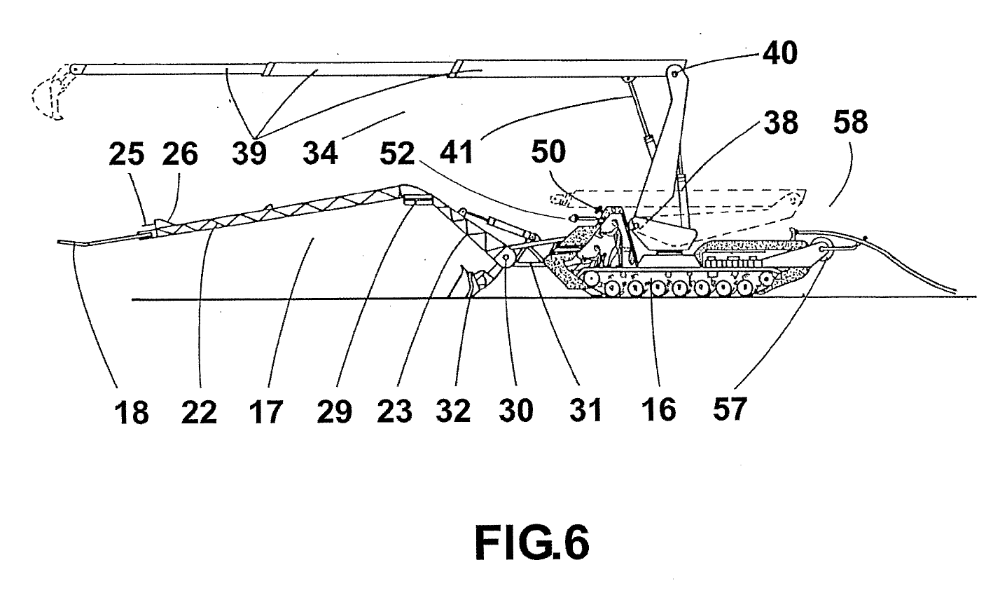

FIG. 6—is a lateral view of the special vehicle.

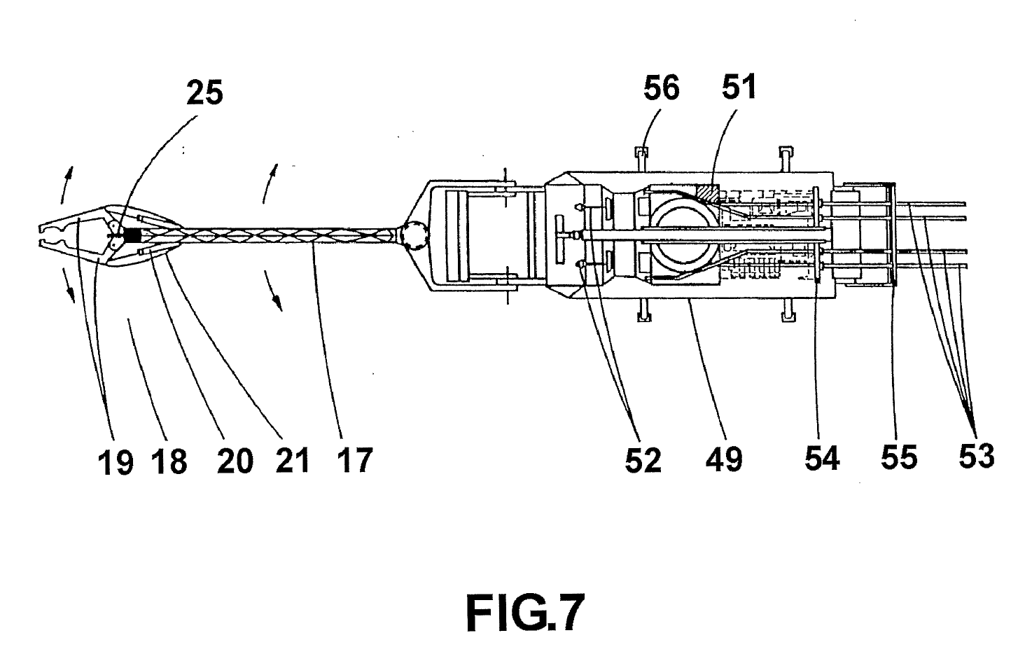

FIG. 7—is a plan view of the special vehicle.

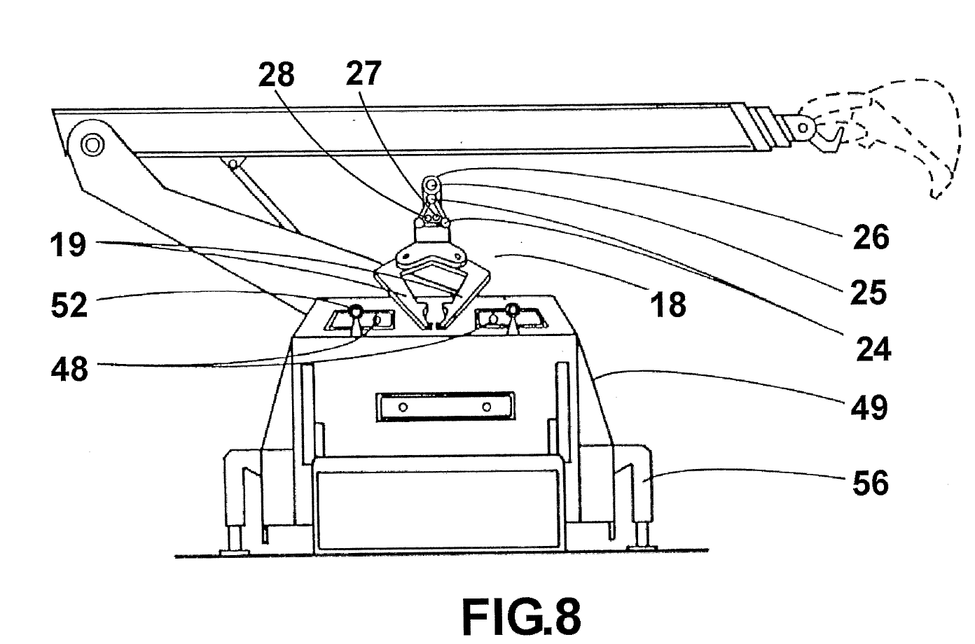

FIG. 8—is a front view of the special vehicle.

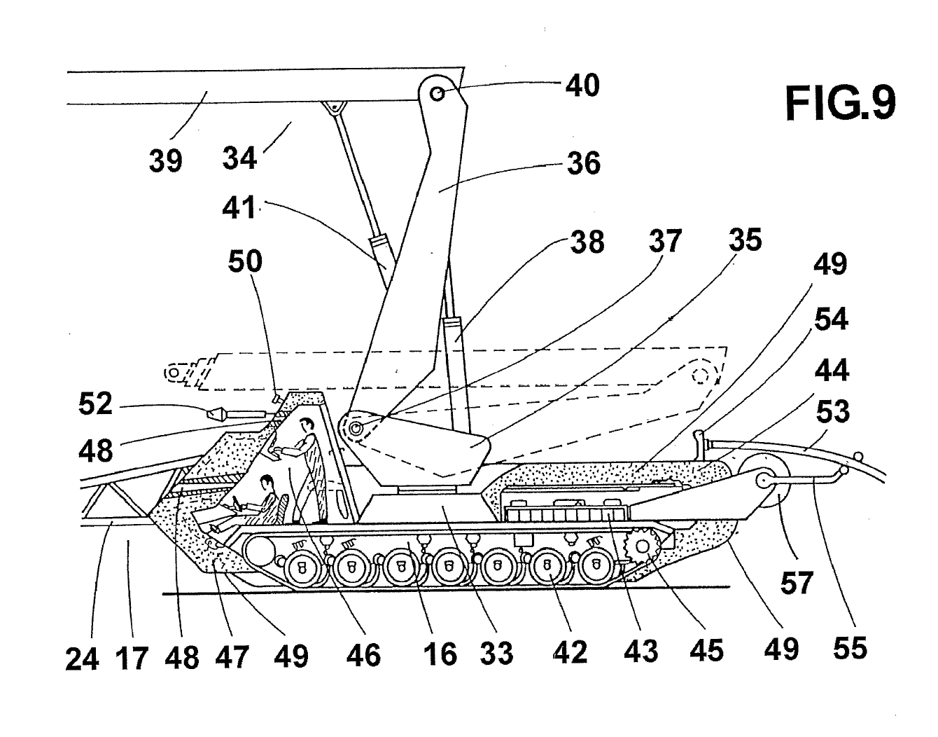

FIG. 9—is an enlarged view of the central core of the special vehicle.

The fire extinguishing and oil and gas well recovery system is characterised by a sequence of operations carried out by means of a special vehicle on caterpillar tracks, the details of the different phases being as follows:

### Phase 1: Positioning of Shields

Once the special vehicle (58) is at the site of the accident, protective metallic shields (7) are strategically placed on the terrain, said shields providing shelter for fire fighters and specialised personnel so that they may direct the water from the water canons (8) towards the well on fire and its surrounding area, by means of the connection of hoses (9).

### Phase 2: Cooling of the Surrounding Area:

From the shields (7), in position at the ideal sites and from the vehicle (58) itself, water is aimed at the well on fire and its surrounding area, the supply of said water being carried out from reservoirs (10) that may be built near to oil mines to prevent accidents.

### Phase 3: Cleaning and Protection of Surrounding Area:

During this phase the surrounding area is cleaned using, simultaneously, the bucket of the jib crane (34) incorporated in the special vehicle (58) and the hydraulic shovel (32), located on the front of said vehicle. In addition to cleaning away objects, an earth parapet (11) is prepared to protect the special vehicle (58) when the explosion at the well is carried out.

### Phase 4: Explosives and Detonation:

From the special vehicle (58) an articulated arm (17), located on its structure, is operated. Said articulated arm (17) having a pincer (18) at its end which, in addition to being able to carry out all types of operations, is specially designed to be able to grasp the explosive charge (12) and take it to the well.

### Phase 5: Extinguishing:

To extinguish the well on fire, explosives (12) can be used or liquid nitrogen, the choice being made according to the characteristics of the accident. The special vehicle (58) is totally effective in both cases, since it can approach to within less than 18 metres of the well and, by means of the articulated arm (17) and pincer (18), position and detonate the explosive charge (12), if this solution is chosen.

If the solution of liquid nitrogen is chosen to extinguish the well, a chimney or tube (13) must be placed at the wellhead, by means of the pincer (18) on the articulated arm (17) (gripping the bottom part) and by means of the hook on the telescopic crane (34) bucket (gripping the top part). Once in place, liquid nitrogen is poured inside by means of a hose (28) housed inside the structure of the articulated arm (17).

### Phase 6: Recovery of Well:

Once the fire has been extinguished, a chimney or tube (14) is placed at the wellhead, and the same steps as in the previous phase are repeated, cleaning of the mechanisms affected, to carry out the operations of clamping, fitting of a new BOP, or fitting of a Christmas tree (15), so that the well is in a totally recovered state and ready for operation.

The fire extinguishing and oil and gas well recovery system includes a special vehicle (58) that consists of a commercial chassis (16) on the front of which is an articulated arm (17) at the free on of which is a pincer (18), comprising two fingers (19) operated by means of two hydraulic cylinders (20), protected against the heat by means of housings (21).

The articulated arm (17) comprises two sections, one front section (22) and one rear section (23), the design of which is based on a triangular structure, whose longitudinal members are rectangular tubes (24). Inside the articulated arm there are cylindrical tubes through which water flows towards the water canon (25) protected by a heat-protection safety shield (26).

Inside the articulated arm (17) is housed a tube (27) that corresponds to the hydraulic system and another tube that corresponds to the liquid nitrogen conduit (28), insulated with asbestos.

Movements of the front section (22) to the right and left are carried out by means of the rotation crown (29) that is anchored to the rear section (23), which, at its opposite end is linked to the rotation point (30) that permits ascending and descending movements.

The rotation point (30) located at the front end of the support (31) anchored to the chassis (16), is also linked to the arms of the hydraulic shovel (32), allowing them to be operated.

Towards the centre of the unit and above the chassis (16) there is a turntable (33) and also the crane (34).

The telescopic crane (34) comprises a support (35) linked to the arm (36) by means of a rotation point (37), and its operation is carried out by means of a hydraulic cylinder (38). The elevating and descending movement of the telescopic sections (39) is carried out by means of the rotation point (40) located at the top end of the arm (36) and with the aid of the hydraulic cylinder (41)

The telescopic sections (39) expand in the conventional way and the free end can be fitted with devices that are common in this type of cranes, such as a hook and back digger.

The vehicle travels by means of two sets of caterpillar tracks (42) at either side of the chassis (16), which are driven by the corresponding motorisation (43), protected by means of a heat protection safety shield (44) and acting on the corresponding drive wheels or toggles (45).

The cabin (46) located towards the front of the special vehicle (58), is provided with all of the means for the control and handling of the different devices that are included in the unit, being protected by means of heat installation (47), and having a correct cooling and air renewal system.

In order to have a correct view of the exterior, the cabin (46) is equipped with multiple optical sights (48) arranged at different heights.

Cooling of the special vehicle (58) is by means of an enveloping casing (49) in a stainless steel based laminar material and with the aid of the sprinkler (50), to dampen the whole of the exterior of the vehicle.

The water equipment comprises the central hydraulic system (51), to provide pressurised water according to the needs of the different water projecting elements, such as the sprinkler (50), and the water canons (52), the water being channelled by multiple hoses (53) towards the connection point located on the support (54).

The hoses (53) located at the rear of the vehicle are guided by means of the guide support (55).

To ensure that the special vehicle (58) is perfectly stable when stationary, it is provided with four, conventional outriggers or support points (56) that operate vertically.

In addition, on the rear of the special vehicle (58), there is a counterweight (57) that is capable of guaranteeing the stability of the whole unit when it is in operation or moving.

It was decided to omit a detailed description of the other particular features of the system being disclosed or of the components forming part of it, as it was felt that the rest of said particular features are not the object of any claims.

Having described the nature of the present invention in sufficient detail, in addition to the means of putting it into practice, all that remains to be added is that its description is not restrictive, and that variations both in materials and shapes and sizes can be made provided that said variations do not alter the essential nature of the characteristics claimed below.

1. Fire extinguishing and gas and oil well recovery system, which is particularly suitable for use in oil and petrochemical mining, characterised in that it comprises a detailed sequence of operations that are performed by means of a special vehicle (58) according to the following phases (1) Positioning of shields, (2) cooling of surrounding area, (3) cleaning and protection of surrounding area, (4) explosives and detonation, (5) extinguishing and (6) recovery of well.

2. Fire extinguishing and oil and gas well recovery system, according to claim 1 wherein, in the shield positioning phase (1) protective metallic shields (7) are placed strategically on the terrain by means of a jib crane (34), incorporated in the special vehicle (58), in which the fire fighters or specialised personnel can take shelter and aim the water projected from water canons (8) towards the flames of the well on fire by means of the connection of hoses (9).

3. Fire extinguishing and oil and gas well recovery system according to claim 1, wherein, in the cooling of the surrounding area phase (2), water is directed towards the flames of the well on fire from the water canons (8) positioned at the (shields (7) and from the water canons (52) of the special vehicle (58), said water being supplied from the reservoirs (10) that are built near to oil mines for the prevention of accidents or from mobile tankers.

4. Fire extinguishing and oil and gas well recovery system according to claim 1, wherein, in phase of cleaning and protecting the surrounding area (3), the surrounding area is cleaned by means of the bucket on the jib crane (34) incorporated in the special vehicle (58) and the hydraulic shovel (32), located at the front of this vehicle which, at the same time as it cleans away objects, prepares an earth parapet (11) to protect the special vehicle (58) when the well explosion is carried out.

5. Fire extinguishing and oil and gas well recovery system according to claim 1, wherein, in the explosive and detonation phase (4), from the special vehicle (58) an articulated arm (17) located on its structure, with a pincer 18) at its end, is operated. Said pincer (18) in addition to being able to carry out any other operation, is specially designed to grasp the explosive charge (12) and take it near to the well itself.

6. Fire extinguishing and oil and gas well recovery system according to claim 1, wherein, in the extinguishing phase (5), either explosives (12) or liquid nitrogen contained in a conduit (28) housed in the structure of the articulated arm (17), incorporated in the special vehicle (58), are used.

7. Fire extinguishing and oil and gas well recovery system according to claim 1, wherein, in the extinguishing phase (5), when explosives (12) are used, the explosive charge (12) is placed at the wellhead by means of the articulated arm (17) and pincer (18) on its free end, and detonation is carried out from the cabin (46) controls located in the front part of the special vehicle (58).

8. Fire extinguishing and oil and gas well recovery system according to claim 1, wherein, in the extinguishing phase (5), when liquid nitrogen is used, a chimney or tube (13) is placed at the wellhead, by means of the pincer (18) on the articulated arm (17), holding the bottom part of said chimney or tube (13) and, pouring the liquid nitrogen inside by means of a conduit (28).

9. Fire extinguishing and oil and gas well recovery system according to claim 1, wherein, in the well recovery phase (6), once the fire has been extinguished, a chimney or tube (14) is placed on the wellhead, repeating the same steps as in the previous phase, allowing operations of clamping, fitting a new BOP or installing a Christmas tree (15) to be carried out, totally recovering the well and leaving it ready for operation.

10. Fire extinguishing and oil and gas well recovery system according to claim 1, wherein, the special vehicle (58) includes a commercial chassis (16) with caterpillar track (42) type transmission, whilst on the front is located an articulated arm (17) and a hydraulic shovel (32), linked to the chassis (16) by a support (31) by means of a rotating axle (30).

11. Fire extinguishing and oil and gas well recovery system according to claim 1, wherein, located on the centre of the special vehicle (58) is a turntable (33) on which a crane with a telescopic arm (34) moves, the control cabin (46) being located in the front zone, whilst the motorisation (43), counterweight (57) and hoses (53) connected to the support (54) and led by the guide support (55), are located in the rear zone.

12. Fire extinguishing and oil and gas well recovery system according to claim 1, wherein, the articulated arm (17) comprises a front section (22) and a rear section (23) linked by means of a rotation crown (29), equipped at the free end of the section (22) with a pincer (18) formed by fingers (19) operated by means of hydraulic cylinders (20), protected from the heat by fire-resistant housings (21).

13. Fire extinguishing and oil and gas well recovery system according to claim 1, wherein, sections (22 and 23) of the articulated arm (17) are formed by a triangular structure based on cylindrical tubes (24) arranged longitudinally, through which the hydraulic system hose (27) and the liquid nitrogen conduit (28) run, whilst water is also made to flow towards the water canon (25), located at the free end of the section (22) and protected by a heat-protection safety shield (26).

14. Fire extinguishing and oil and gas well recovery system according to claim 1, wherein, the jib crane (34) comprises, on its base, a support (35) linked to the arm (36) at its bottom part, by means of a rotation point (37), whilst the top end of the arm (36) is linked to the telescopic sections (39) at the free end of which a conventional hook or back digger can be placed, elevating and descending movements being carried out by means of hydraulic cylinders (38 and 41).

15. Fire extinguishing and oil and gas well recovery system according to claim 1, wherein, the cabin (46) is located in the front zone of the vehicle and protected from the heat by means of thermal insulation (47), equipped with an air cooling and renewal system and multiple optical sights (48) from which the general surrounding area can be controlled.

16. Fire extinguishing and oil and gas well recovery system according to claim 1, wherein, on the outside front of the cabin (46) towards to the top part, there is a water sprinkler (50), the same cabin front also being fitted with two or more pressurised water projection canons (52).

17. Fire extinguishing and oil and gas well recovery system according to claim 1, wherein, the motorisation (43) located in the rear zone, has been protected against the heat by means of a housing or safety shield (44).

18. Fire extinguishing and oil and gas well recovery system according to claim 1, wherein, the whole body of the special vehicle (58) has been enveloped with a protective casing (49) of stainless steel-based laminar material.

19. Fire extinguishing and oil and gas well recovery system according to the claim 1, wherein, the perfect stability of the special vehicle (58) when stationary, is achieved by means of four conventional, vertically-operating outriggers or support points (56).
